(19) United States
(12) Patent Application Publication
(10) Pub. No.: US 2004/0248623 A1
(43) Pub. Date: Dec. 9, 2004

(54) Hands free accessory for wireless telephones

(75) Inventors: Robert N. Nelson, Scottsdale, AZ (US); Richard J. Augustine, Scottsdale, AZ (US); Juan C. Vazquez, Lakewood, CO (US)

Correspondence Address: Dillis V Allen Esq, 105 S Roselle Road, Suite 101, Schaumburg, IL, 60193, US

(73) Assignee: SAFCO Corporation

(21) Appl. No.: 09/862,643

(22) Filed: May 22, 2001

(51) Int. Cl. H04M 1/00

(52) U.S. Cl. 455/569.1; 455/557

(57) ABSTRACT

An aftermarket hands free unit for mobile wireless telephone use in a vehicle. The hands free unit commands the telephone to enter either an active hands free mode, AHF, or alternatively, a privacy hands free mode, PHF, in response to a user-operated switch on the unit. In one embodiment, these commands are generated by a microprocessor in the unit that sends an ID inquiry to the phone that enables the unit to identify and be used with different model phones. This microprocessor also repeats AHF and PHF commands to the telephone to maintain the desired mode. The hands free speaker in the unit is uniquely clam shelled between the housing and a circuit board, and mode switching is effected by a clever optical switch mounted in a finger recess in the unit housing. Duplexing is fixed by the unit to appropriately marry the capabilities of the phone.

### BACKGROUND OF THE INVENTION

The present invention relates to hands free systems and particularly to a stand-alone hands free unit that plugs into a vehicular power socket and includes an internal hands free speaker and built-in microphone circuitry connectable to a small hands free microphone that may be clipped, for example, on the visor of the vehicle near the driver's position. Mobile phones include an internal microphone and an internal speaker that need to be turned off during the hands free mode, and at the same time the telephones internal audio circuits corresponding to these functions need to be connected into the hands free unit.

It is also desirable that the hands free system be capable of turning to a privacy hands free mode(PHF) in which the user can talk directly into the phone bypassing the active hands free system. To do this, the internal telephone audio circuits need to be reconnected to the telephone's internal microphone and speaker, and at the same time the hands free system speaker and microphone need to be disconnected.

While these functions have in the past been effected in built-in vehicular systems, they have not been adequately incorporated thusfar into an aftermarket stand alone hands free system capable of manually switching between the AHF mode and the PHF mode.

The traditional approach for providing hands free speaker phones is through an installed system that utilizes a separate microphone embedded somewhere in the vehicle and produces the acoustic path through either the audio speakers in the vehicle or through separate add-on audio speakers. This process requires high skills from a trained installer and is an expensive solution. Moreover, the cellular phone is frequently permanently installed in a vehicle although there are some installed cellular car kits that allow removal of the cellular phone from an installed cradle.

Another significant problem in the development of aftermarket hands free technology is that the internal software and contact terminal configuration of telephones vary significantly from one manufacturer to another and in fact from one model to another from individual manufacturers. Therefore, it has been difficult and in some cases impossible to design a single hands free unit that is capable of being used with more than one model wireless telephone, and the present invention addresses this specific problem.

It is, therefore, a primary object of the present invention to provide a hands free unit for wireless telephones that ameliorates the problems noted above.

### SUMMARY OF THE PRESENT INVENTION

According to the present invention, an aftermarket hands free unit is provided for mobile wireless telephones that commands the telephone to enter either an active hands free mode, AHF, or alternatively, a privacy hands free mode, PHF, in response to a user-operated switch on the unit. In one embodiment, these commands are generated by a microprocessor in the unit that sends an ID inquiry to the phone that enables the unit to identify and be used with different model phones. This microprocessor also repeats AHF and PHF commands to the telephone to maintain the desired mode. The hands free speaker in the unit is uniquely clam shelled between the housing and a circuit board, and mode switching is effected by a clever optical switch mounted in a finger recess in the unit housing. Duplexing is fixed by the unit to appropriately marry the capabilities of the phone.

In cases where the telephone has internal software that is capable of downloading telephone ID packet data to external components, the present unit includes a microprocessor that sends an ID request packet to the telephone and receives an ID packet from the telephone. This ID packet is used by the microprocessor to select a value from a “Big Lookup Table” also in the microprocessor, that contains a plurality of values or codes, one corresponding to individual telephone models. This value, BTV, is incorporated by the microprocessor into an AHF packet which activates the AHF mode in the telephone. The microprocessor has a similar methodology for developing and sending a PHF packet to the telephone for the PHF mode.

Upon connection of the present hands free unit into the power outlet of a vehicle, an indicator light glows giving the status of the HFA(Hands Free Accessory). The indicator light can be a single color LED, or a bi-color LED for other cellular phones made by specific manufacturers. The circuitry allows great flexibility in the multiple use of the power status indicator to show not only that the HFA is powered but also to indicate the status of the cellular telephone as to its mode—privacy or hands free. The indicator light also confirms that the unit is supplying charger power to the cellular telephone if the connector has been inserted into the base of the telephone.

Upon connection of the HFA to the phone base, the circuitry senses the connection to the telephone thereby sending a signal through a data line and turning the phone to its “on” position, and in the case of phones having appropriate software causing the “car” mode to show on the screen of the phone. The HFA's microprocessor begins a series of queries to the phone's software. The most critical information to be acquired is the phone's model number so that the appropriate parameters of the phone can be set up within the HFA. A series of queries from the microprocessor and the appropriate responses from the cell phone provide the HFA with the manufacturer's model number. This in turn is used by the microprocessor and memory storage to program the microprocessor data bus of the HFA so that it can communicate appropriately with the cellular phone. The microprocessor is capable of establishing different communication bus protocols as well as establishing battery charger parameters and other appropriate interface criteria. This circuitry encompasses HFAs that utilize complex microprocessor communication and interrogation technology as well as more simplified versions that do not require such advance microprocessor technology.

Further, the present microprocessor software interrogates phones that have encrypted data bus and model information and uses the unique look-up table referred to above in other microprocessor locations to decode the encrypted data.

The intelligent circuitry used in the present HFA design provides a significantly unique approach designed to minimize stock keeping units(SKUs). A less unique and sophisticated approach would be to have one SKU for each model of phone or for just a few models of phones. This approach enables the present unit to be compatible with various wireless communication standards(for example, CDMA, GSM, TDMA, etc.), coupled with the smart microprocessor approach that utilizes stored data banks and look-up tables specifically designed to maximize the number of models of each manufacturer's cell phones, or in some cases different manufacturers, that can be compatibly serviced by a single HFA stock keeping unit.

Another major embodiment is the unique use of acoustic monitoring and control of speaker and microphone gain to minimize network echo, feedback, speech clipping, what is referred to as “water fall” noise, CDMA network noise and other phenomenon of mobile telephone networks that tend to degrade voice quality. Superior voice quality is a basic and fundamental difference between this aftermarket hands free unit and previously available products. This superior voice quality is maintained while the phone is in both digital and analogue modes.

Another functional advantage and feature of this hands free unit is its ability to be attached and disconnected to a wireless phone while the phone is on an active call without dropping the call. This feature allows the user to enter the vehicle while on a call and then transfer to the hands free unit and begin driving without dropping the call and having to call back. Similarly, the user can be using the hands free unit in the vehicle and disconnect the phone from the hands free unit and continue the call without dropping the call.

### BRIEF DESCRIPTION OF THE DRAWINGS

FIG. 1 is a top perspective view of the present hands free accessory(HFA);

FIG. 2 is a top view of the hands free accessory showing the speaker grill;

FIG. 3 is a left side view of the hands free accessory shown in FIGS. 1 and 2;

FIG. 4 is a bottom view of the hands free accessory shown in FIGS. 1 to 3;

FIG. 4a is a top view, partly fragmented, of the optical switch recess illustrated in FIG. 4;

FIG. 5 is a front view illustrating the volume control wheel;

FIG. 6 is a bottom view of the circuit board and power supply terminals integral therewith;

FIG. 6a is an enlarged fragmented view of the designated part of FIG. 6 showing the hands free microphone connector;

FIG. 7 is a top view of the circuit board illustrated in FIG. 6;

FIG. 8 is an exploded view of the clam shelled housing assembly;

FIG. 9 is an enlarged section of one of the optical sensing elements;

FIG. 10 is a sub-assembly of the optical switch assembly;

FIG. 11 is a top view of a slightly modified embodiment similar to FIG. 2;

FIG. 12 is a perspective view of a typical vehicular installation;

FIG. 13 is a block diagram of the on board audio circuitry system and power supply, and;

FIG. 14 is a block diagram of the on board microprocessor system and power supply;

FIG. 15 is a macro flow chart for the circuit board mounted microprocessor illustrated in block diagram form in FIG. 14;

FIG. 16A is the initial flow chart for the active hands free mode, AHF;

FIG. 16B is the remainder flow chart for the active hands free mode, AHF, and;

FIG. 17 is the flow chart for the privacy hands free mode, PHF.

### DETAILED DESCRIPTION OF THE PREFERRED EMBODIMENTS

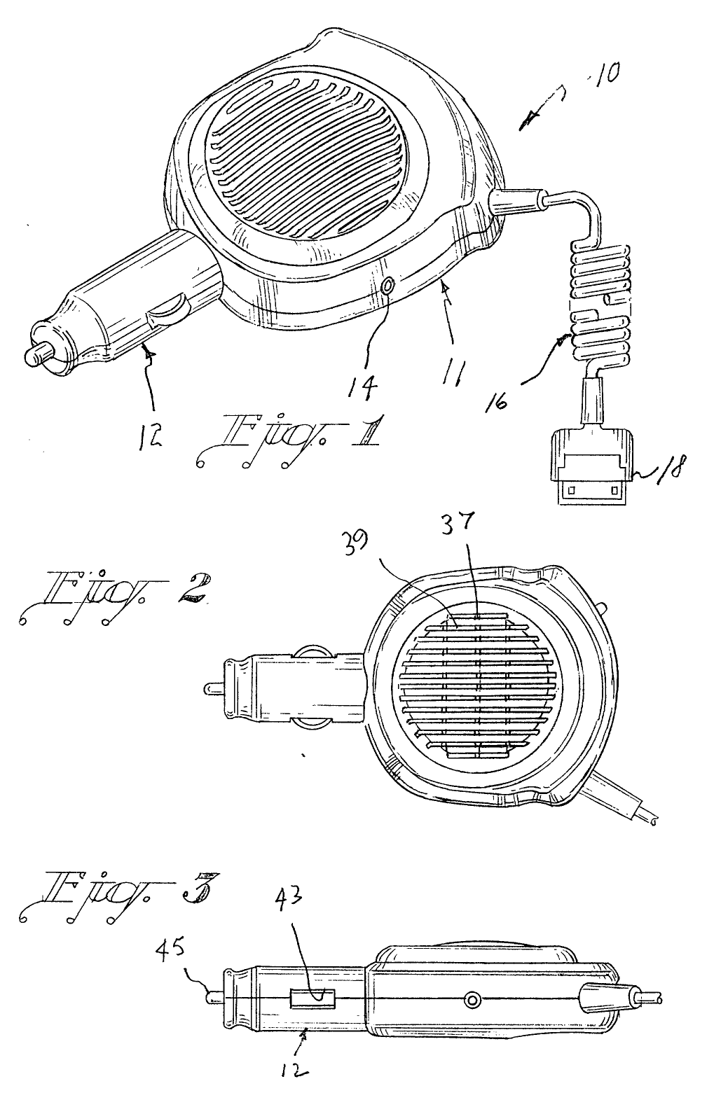

Referring to the drawings and particularly FIGS. 1 to 12, a hands free accessory unit 10(HFA) is illustrated including a housing assembly 11, with a projecting nose piece 12 insertable into a vehicle power supply socket, a hands free microphone connector 14 adapted to receive a connector on the end of a hands free microphone assembly 15(FIG. 12), and a telephone connector assembly 16 having a multiple terminal connector 18 that plugs into the base of a mobile wireless telephone 20 as shown in FIG. 12.

In FIG. 12, a typical installation is illustrated including a dashboard mounted cradle 21 for holding phone 20, the hands free unit 10 mounted with nose piece 12 plugged into a dashboard lighter socket 23, which it could also be a similarly sized socket that is separate from the lighter. This connection, of course, provides 12 volt DC power to the hands free unit 10.

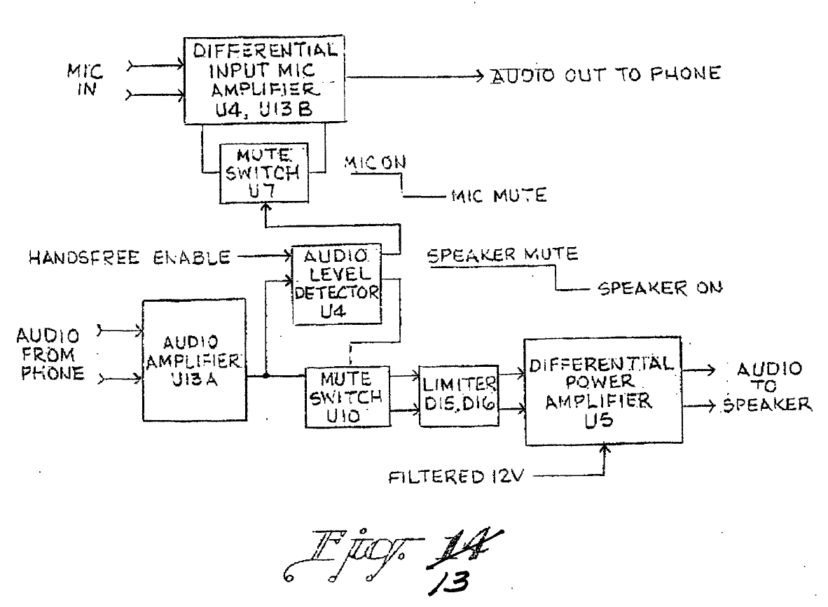

There are four basic elements that are controlled by the present hands free unit 10. These four elements include the internal audio circuitry in the telephone 20 for the internal microphone in the telephone, and the internal speaker in the telephone; the hands free microphone circuitry in the unit 10, and the circuitry for the hands free speaker 25 shown in an exploded view in FIG. 8.

The hands free unit 10 has two modes: the first being an active hands free, termed AHF, and the second being a privacy hands free, termed PHF. In the Active Hands Free mode, the on board circuitry disconnects the audio circuitry in the telephone 20 from the telephone's internal microphone and speaker and connects that audio circuitry into the hands free unit 10. At the same time, the circuitry for speaker 25 and the circuitry for microphone assembly 15 are enabled or activated.

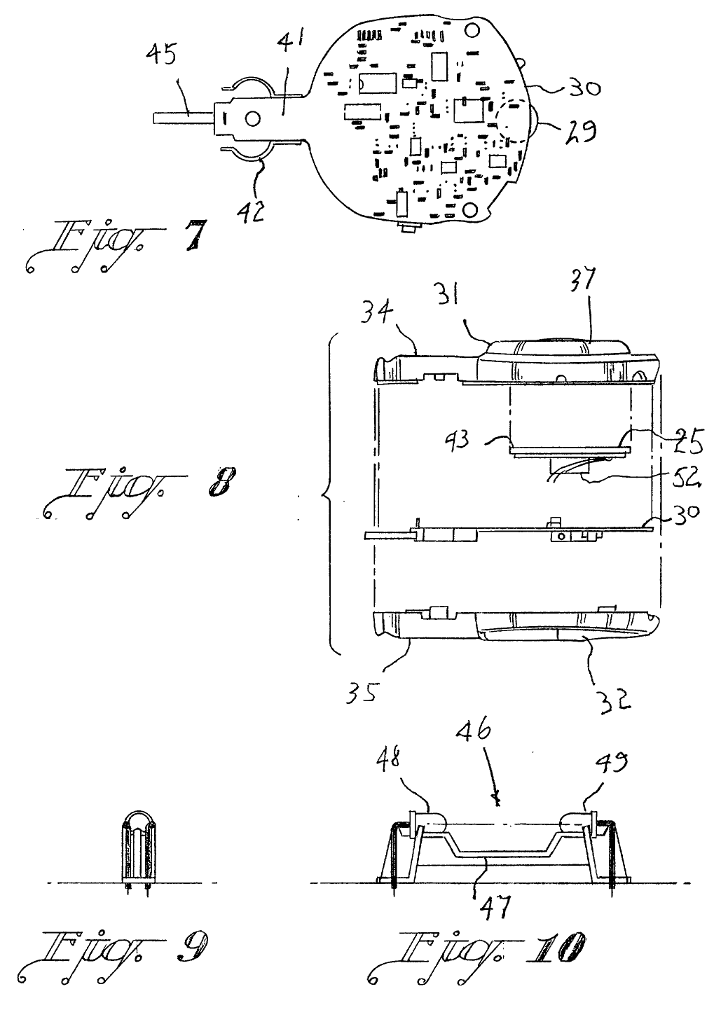

In the Privacy Hands Free mode, activated by the user interrupting an optical switch assembly 27, as shown in FIGS. 4 and 4a, with the user's finger, the unit 10 reconnects the internal telephone audio circuitry to the telephone internal microphone and speaker and disables the HFA unit 10 microphone and hands free speaker circuitry. In the PHF mode, the user operates telephone 20 as a normal phone.

In addition to optical mode switch 27, the HFA unit 10 has a volume control 29 on the front of the unit 10.

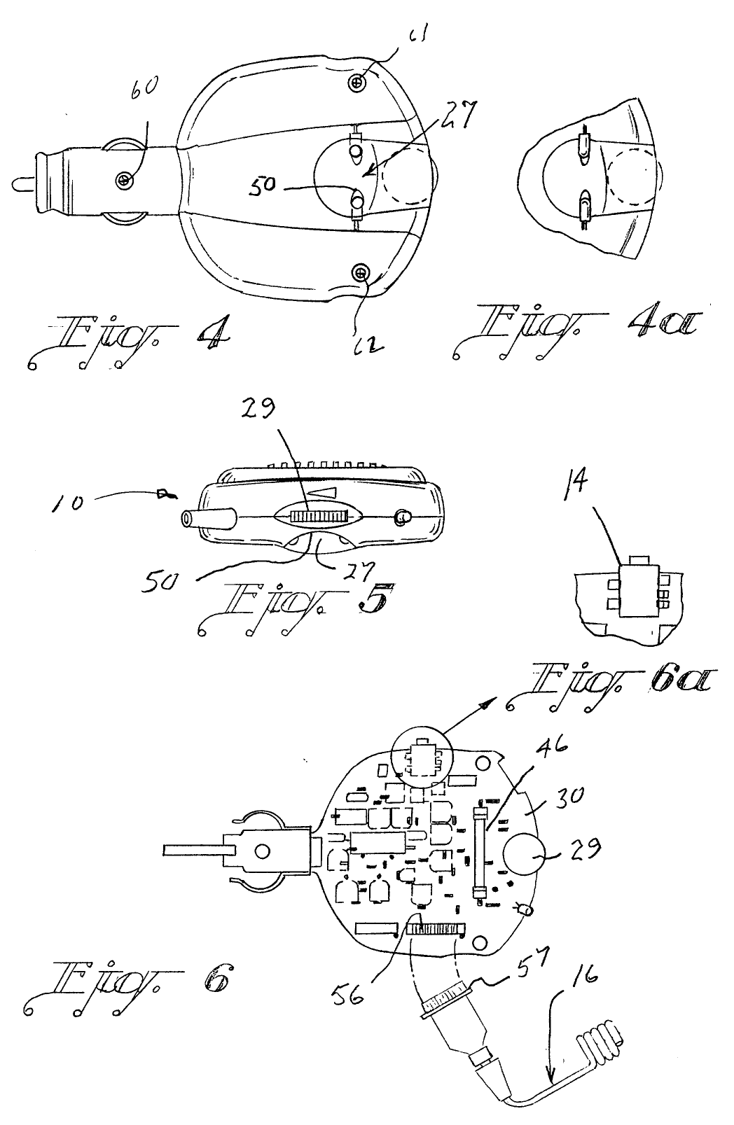

In this regard, the orientation of the unit 10 as described herein is generally with reference to its position shown in FIG. 12, except the top refers to the speaker grill shown in FIG. 2, even though it may be rotated toward the vehicle operator to improve the acoustics.

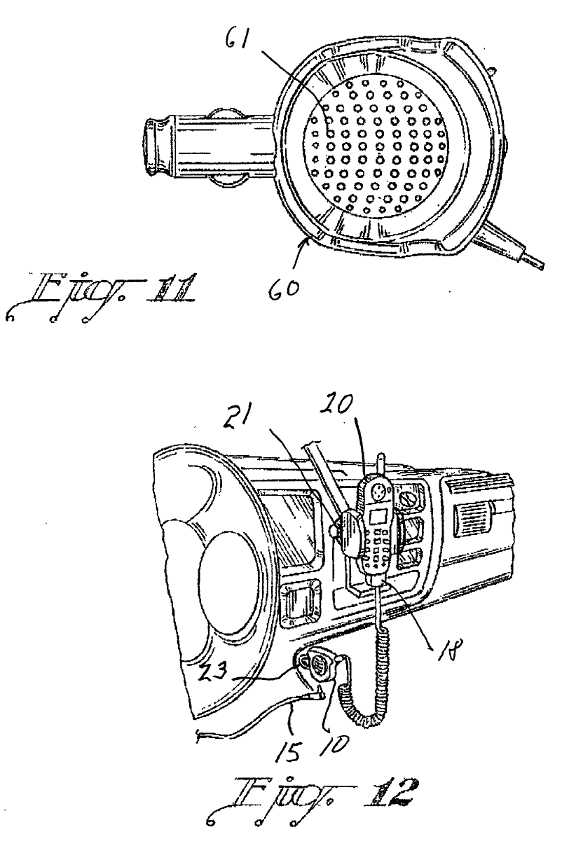

As seen in FIGS. 6, 7, and 8, a generally circular circuit board assembly 30 is clam shelled between an upper housing section 31 and a lower housing section 32. The nose piece 12 is defined by an integral semi-annular extension 34 on the upper housing section 31 and a mating semi-annular extension 35 on the lower housing section 32. The upper housing section 31 has an integral grill 37 defined by a plurality of generally parallel spaced ribs 39.

As seen in FIG. 7, the circuit board 30 has a rearward extension 41 that carries spaced arcuate contacts 42 that engage power supply contacts in vehicle socket 23 to provide the necessary 12 volt power to the hands free unit 10. The nose piece 12 has recesses 43 that receive the contacts 42. Another axial contact 45 extends forwardly from extension 41.

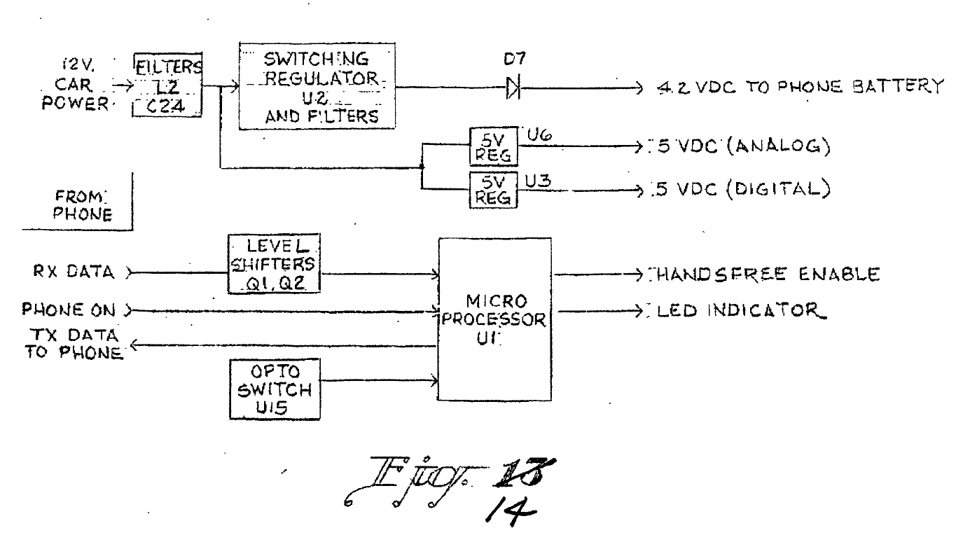

All of the circuitry for the hands free system, including audio circuitry hardware, power supply, and microprocessor circuitry is carried by circuit board 30. Furthermore, the switch sub-assembly 46 illustrated in FIG. 10 is mounted on the lower surface of circuit board 30 as shown in FIG. 6. The volume control wheel 29 is also mounted on the circuit board as shown in FIG. 6, and the microphone connector 14 is also mounted on the bottom of the circuit board as also shown in FIG. 6. The optical switch assembly 46 includes a mounting wireform 47, a light transmitting element 48, and a light receiving element 49 carried thereby. The optical elements 48 and 49 project through openings 50 in an arcuate elongated recess 50 in the bottom housing section 32 that opens to the front of the unit 10 just below the volume wheel 29 for operator convenience. The arcuate recess 50 aids the user in operating the switch with the user's right-hand index finger, for example, without looking for the switch. Similarly, the volume wheel 29 can be located without the user taking his or her eyes off the road.

As seen in FIG. 8, the circuit board and speaker 25 are clam shelled between the upper housing section 31 and the lower housing section 32. A plurality of ribs in the inside periphery of the upper housing section and the inside periphery of the lower housing section engage respectively the upper and lower surfaces of the periphery of the circuit board 30 to hold the circuit board securely in position. A thin layer of foam 52, glued to the rear surface of the speaker 25, is compressed against the top of the circuit board 30 when the housing sections 31 and 32 are clam shelled so that the forward rim 53 engages the inside of the grill dome 37 as the foam 52 is compressed against the circuit board 30. Speaker rim portion 43 can also be glued inside the upper housing section dome 37 if desired.

In this way the speaker 25 is held securely in position without any additional mounting elements. The lower surface of the circuit board 30 also carries a connector 56 for receiving a mating connector 57 on the end of assembly 16.

The housing sections 31 and 32 are held clamped together by three screws 60, 61, and 62 as seen in FIG. 4.

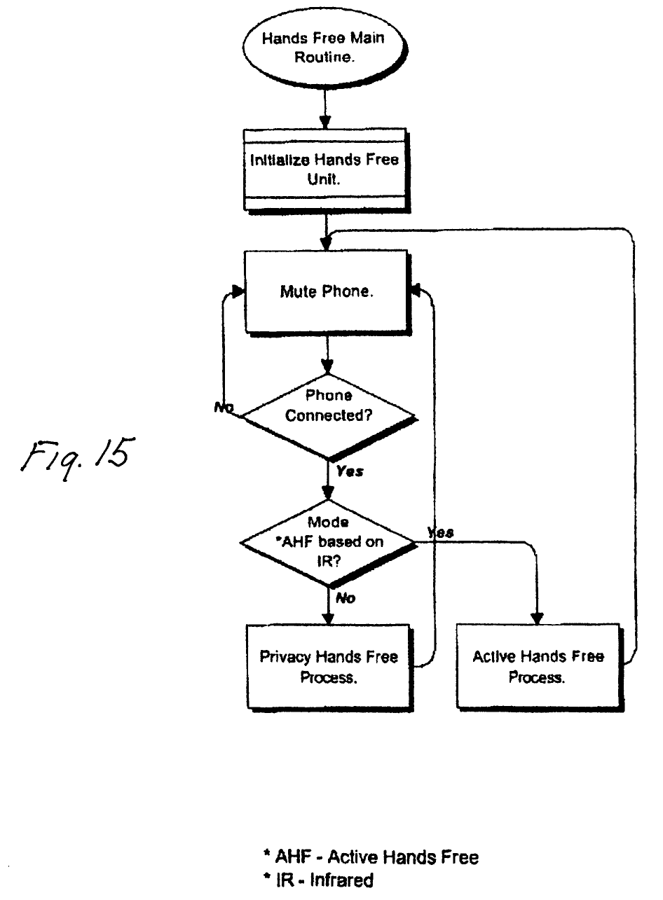

An additional embodiment unit 60 is shown in FIG. 11 differing only with grill 61 having circular apertures as opposed to the rectangular apertures defined by the ribs 39 in the FIGS. 1 to 10 embodiments.

The present embodiment includes ¾(three quarter) duplexing in the hands free mode to match specific telephone types, but other types of duplexing can be provided for other phone types.

Full duplex communication allows both parties to hear each other talk simultaneously. This is the natural way to talk. The advantage to this is that either party can interrupt the other regardless of who is talking.

Three quarter duplex system allows both sides to hear each other talk, however, the audio received on the landline side is attenuated by 6 to 20 db when the landline side is talking. This is done to minimize echo when operating with a phone which does not provide adequate echo cancellation. This attenuated audio will only be experienced on the landline side.

Half duplexing only allows one side of the conversation to be transmitted at a time. In this system, the landline controls the half duplex function; i.e., audio coming from the landline will block audio being sent by the handsfree unit. Only when the landline side stops talking, can the other side be heard. The advantage of this system is that there is no feedback path for the audio thus, there is no annoying echo to contend with. The disadvantage to this system is that it gives control over the conversation to the party being called by the handsfree unit. In some implementations, a constant background noise source can be detected and blocked by the half duplex circuit.

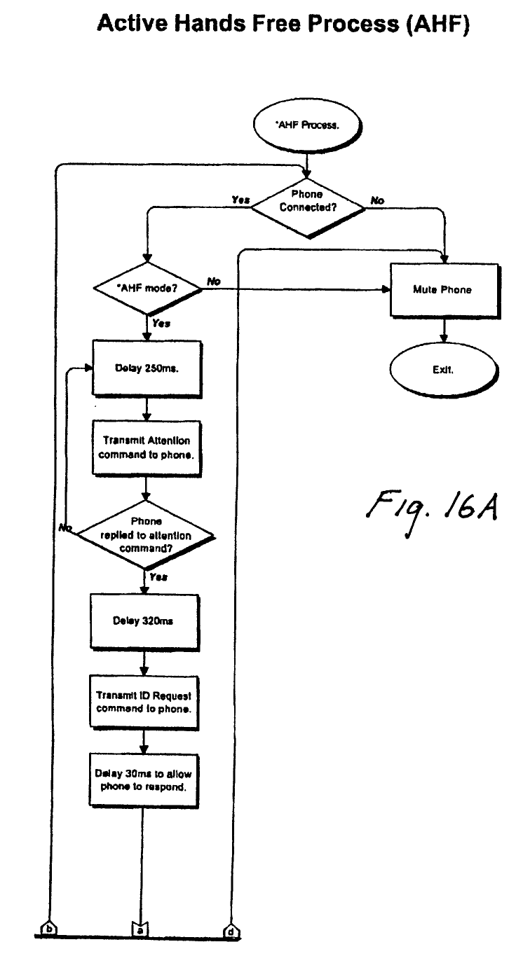

FIG. 13 is a block diagram of the audio circuitry hardware for the HFA microphone and hands free speaker. An external microphone(MIC IN) is connected to the input amplifier(DIFFERENTIAL INPUT MIC AMPLIFIER U4, U13B). This provides the proper bias current for the microphone element. The signal is filtered, buffered, noise in the signal is canceled and the audio signal(AUDIO OUT TO PHONE) is sent to the phone. To suppress echo when in a call, the mute switch is activated through(MUTE SWITCH U7) reducing the microphone channel gain by 20 db. This occurs when audio is detected in the speaker channel(AUDIO LEVEL DETECTOR U7).

When the (HANDSFREE ENABLE) signal is received from the microprocessor and an audio signal is received from the (AUDIO AMPLIFIER U13A), the mute switches (MUTE SWITCH U7 AND MUTE SWITCH U10) are activated to attenuate the microphone and unmute speaker amplifier (AUDIO AMPLIFIER U13A AND DIFFERENTIAL INPUT MICROPHONE AMPLIFIER U4, U13B) outputs. This corresponds to the ¾ duplexing described above. One half (½) duplexing is effected by completely disabling the microphone transmission under these conditions.

When the (HANDSFREE ENABLE) signal is received from the phone(AUDIO FROM PHONE) this signal is sent to the audio amplifier(AUDIO AMPLIFIER U13A) where the signal is amplified, the speaker is unmuted through (AUDIO LEVEL DETECTOR U4 and MUTE SWITCH U10). The audio signal is passed through (LIMITER D15, D16) where background noise is muted and filtered. The audio signal is amplified (DIFFERENTIAL POWER AMPLIFIER U5) and is sent to the speaker (AUDIO TO SPEAKER). The audio level detection circuit utilizing click less opto resistors will mute noise from the phone going to the speaker, mute the speaker channel at very low voice levels, and reduce feedback(echo) from the speaker.

Noise reduction from and to the phone from the Hands Free unit is accomplished with differential amplifiers. The inverted grounds are summed with the audio signals to cancel noise from the power supply and any extraneous noise from the grounding of the phone.

FIG. 14 is a block diagram of the HFA telephone charging circuit hardware and the microprocessor's associated circuitry.

Power is received from the automobile cigarette lighter or power port (12V CAR POWER). The power is filtered through FILTERS 1,2,C24. This filtered power is provided to regulators (5V REG U6 and 5V REG U3) providing a power supply to the analog and digital circuit (5 VDC ANALOG AND 5VDC DIGITAL). Filtered power is provided also to the battery charging and phone power circuit(SWITCHING REGULATOR U2 AND FILTERS). The switching regulator is operating in a buck configuration reducing the input voltage (12V CAR POWER) to a precisely controlled voltage as required to power the cell phone and charge its battery. In the charging process, the phone manages charging of the battery.

Data is received from the phone(RX DATA) and processed through a transistor network (LEVEL SHIFTERS Q1, Q2) to insure compatibility of the microprocessor and phone signals. This data is then sent to the microprocessor (MICROPROCESSOR U1). The signal that is used to activate the phone(PHONE ON) is also sent to the microprocessor (MICROPROCESSOR U1). The microprocessor(MICROPROCESSOR U1) sends data to the phone via (TX DATA). The optical switch 27(OPTO SWITCH U15 in FIG. 14) controls the operating mode of privacy or handsfree. This optical switch signal is sent to the microprocessor (MICROPROCESSOR U1). The (MICROPROCESSOR U1) will power the mode LED (LED INDICATOR) indicating the state of the handsfree adapter and also sends a signal (HANDSFREE ENABLE) to the (AUDIO LEVEL DETECTOR U4).

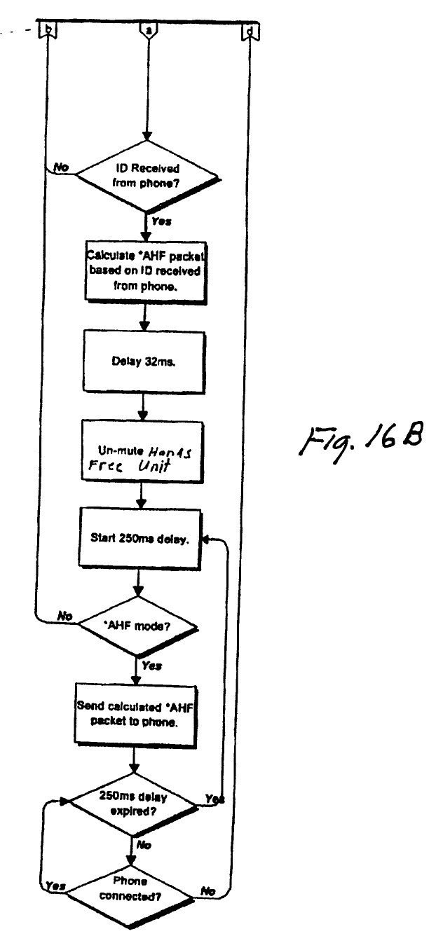

The software in the HFA microprocessor shown in FIG. 14 is represented in the flow charts of FIGS. 15, 16A, 16B and 17. The following definitions apply:

Byte: 8 bit value from 0 to 255.

Nibble: 4 bit value from 0 to 15. There are two nibbles in 1 byte. Higher nibble and lower nibble.

Higher Nibble: 4 most significant bits in a byte. Example: 0×6C, higher nibble is hexadecimal 6.

Lower Nibble: 4 least significant bits in a byte. Example: 0×6C, lower nibble is hexadecimal C.

Attention Byte: Byte sent to phone to get its attention. In this situation the attention byte is hexadecimal 0×C0.

Packet: Multiple bytes sent to or from the phone.

ID Request Packet: Packet that is sent to the phone to query for an identification packet. Consists of 5 bytes, hexadecimal value are: 7F, AF, CA, A1, 7E.

Active Hands Free, AHF, packet: Packet that maintains the phone in an active hands free mode. The packet consist of 6 bytes of which one of the bytes is dependent on the ID packet sent back from the phone. Hexadecimal values are: 7F, AF, CC, 04, <dependent value>. 7E. See below on how to determine the dependent value.

Privacy Hands Free, PHF, packet: Packet that maintains the phone in a privacy hands free mode. The packet consist of 6 bytes of which one of the bytes is dependent on the ID packet sent back from the phone. Hexadecimal values are: 7F, AF, CC, 00, <dependent value>, 7E. See below on how to determine the dependent value.

Heart Beat: A packet that is sent to the phone, either AHF or PHF every 200 ms to maintain hands free mode, either active or privacy modes.

ID Packet: Packet that is sent from the phone to the hands free unit to identify the phone and supply information to the hands free unit as to what byte the Active Hands Free packet and/or Privacy Hands Free packet will contain. Packet consists of hexadecimal values: AF, CA, A1 or A2, <BLKUP>, where <BLKUP> is an offset to determine the AHF and/or PHF packets.

The macro HFA processor is illustrated in FIG. 15. The unit is attached to the automobile cigarette lighter or power port. The HANDS FREE MAIN ROUTINE is started. The routine will INITIALIZE HANDS FREE UNIT. The phone is muted. If the PHONE IS CONNECTED AND THE MODE IS AHF, the ACTIVE HANDS FREE PROCESS is initiated. If the phone is on a call when the HFA is connected, the HFA will not interrupt the call, and the AHF will be activated while the call is proceeding.

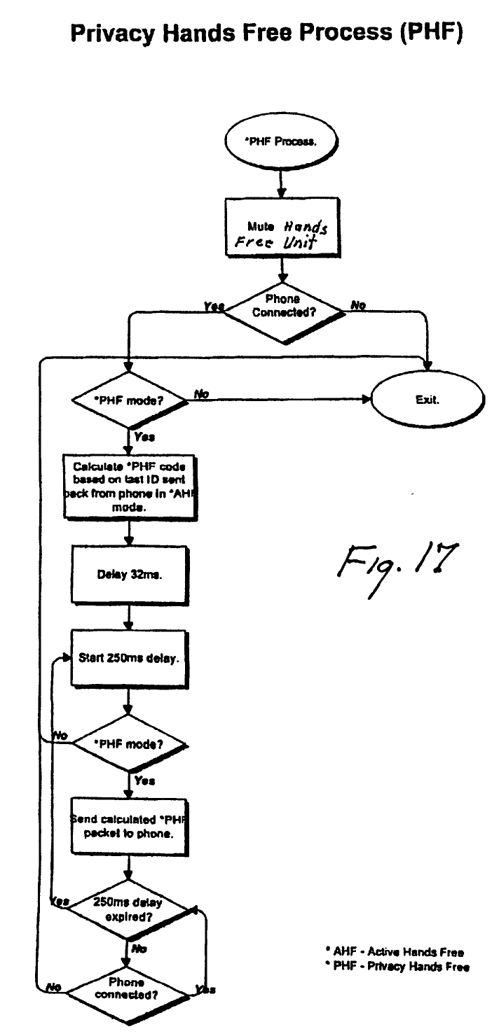

The active hands free process, AHF processor, is illustrated in FIGS. 16A and 16B. If the PHONE IS CONNECTED and the AHF MODE IS ON, there is a delay of 250 ms before a TRANSMIT ATTENTION COMMAND TO PHONE as an attention byte is sent to the phone. If the PHONE REPLIES TO THE ATTENTION COMMAND, a delay of 320 ms is executed. An ID request packet(TRANSMIT ID REQUEST COMMAND TO PHONE) is sent to the phone to determine the phone identification. A delay of 30 ms is executed TO ALLOW THE PHONE TO RESPOND and if the phone responds(ID RECEIVED FROM PHONE), the ID is verified as being a correct ID(CALCULATE AHF PACKET BASED ON ID RECEIVED FROM PHONE) a delay of 32 ms is executed. Then an AHF Packet is sent to the phone(UNMUTE HANDS FREE UNIT) and the handsfree unit is unmuted. A Heart Beat Packet is sent(SEND CALCULATED AHF PACKET TO PHONE) every 250 ms to maintain the phone in AHF mode. This is called the HEART BEAT.

The specific instructions and process are as follows:

1. The hands free unit is muted.

2. A delay of 256 ms is executed.

3. Attention byte, hexadecimal value 0×C0 is sent to the phone.

4. The phone responds to the attention byte with 7F, 7E.

5. A delay of 320 ms is executed.

6. An ID request packet is sent to the phone to query for identification.

7. A delay of 30 ms is executed to allow the phone to respond.

8. The phone responds back with an ID packet, hexadecimal: AF, CA, A1 (or) A2, <BLKUP>. Where <BLKUP> is a value dependent on the phone being queried. The value is used as an offset into a big lookup table. The big lookup table consists of 256 bytes. In this example, let us say that the phone responds with an ID packet containing a value of 0×6C for <BLKUP>. See next step on how to calculate the AHF packet.

9. Calculate AHF packet based on <BLKUP> value. In this example, the <BLKUP> code received is 0×6C. Use value 0×6C received as a lookup table value into the big lookup table. The first digit, 6, represents the row, and the second digit, C, represents the column. Hexadecimal C is a decimal 12. Therefore, for this example, the lookup value can be taken from Row 6, position 12 in the big lookup table. Looking at the big lookup table (below) the value in Row 6, Column 12 is 0×4F. This will be the value inserted into the AHF packet. So the AHF packet becomes: 7F, AF, CC, 04, 4F, 7E, where the 4F is a value dependent on the received <BLKUP> from the ID packet.

10. A delay of 32 ms is executed before the AHF packet is sent to the phone.

11. The hands free unit us unmuted.

12. The AHF packet is sent to the phone every 200 ms. This becomes the heart beat to the phone to maintain the phone in Active Hands Free mode.

Big Lookup Table (Hexadecimal Values), Used to calculate AHF packet

| | |
|---|---|
| Row 0 | 0XFE,0XF0,0XE2,0XEC,0XC6,0XC8,0XDA,0XD4,0X8E,0X80,0X92,0X9C,0XB6,0XB8,0XAA,0XA4 |
| Row 1 | 0X1E,0X10,0X02,0X0C,0X26,0X28,0X3A,0X34,0X6E,0X60,0X72,0X7C,0X56,0X58,0X4A,0X44 |
| Row 2 | 0XA9,0XA7,0XB5,0XBB,0X91,0X9F,0X8D,0X83,0XD9,0XD7,0XC5,0XCB,0XE1,0XEF,0XFD,0XF3 |
| Row 3 | 0X49,0X47,0X55,0X5B,0X71,0X7D,0X6D,0X63,0X39,0X37,0X25,0X2B,0X01,0X0F,0X1D,0X13 |
| Row 4 | 0X50,0X5E,0X4C,0X42,0X68,0X66,0X74,0X7A,0X20,0X2E,0X3C,0X32,0X18,0X16,0X04,0X0A |
| Row 5 | 0XB0,0XBE,0XAC,0XA2,0X88,0X86,0X94,0X9A,0XC0,0XCE,0XDC,0XD2,0XFB,0XF6,0XE4,0XEA |
| Row 6 | 0X07,0X09,0X1B,0X15,0X3F,0X31,0X23,0X2D,0X77,0X79,0X6B,0X65,0X4F,0X41,0X53,0X5D |
| Row 7 | 0XE7,0XE9,0XF8,0XF5,0XDF,0XD1,0XC3,0XCD,0X97,0X99,0X8B,0X85,0X7D,0XEA,0XB3,0XBD |
| Row 8 | 0X35,0X3B,0X29,0X27,0X0D,0X03,0X11,0X1F,0X45,0X4B,0X59,0X57,0X7D,0X73,0X61,0X6F |
| Row 9 | 0XD5,0X0B,0XC9,0XC7,0XED,0XE3,0XFl,0XFF,0XA5,0XAB,0XBA,0XB7.0X9D,0X93,0X81,0X8F |
| Row A | 0X62,0X6C,0X7E,0X70,0X5A,0X54,0X46,0X48,0X12,0X1C,0X0E,0X00,0X2A,0X24,0X36,0X38 |
| Row B | 0X82,0X8C,0X9E,0X90,0XBA,0XB4,0XA6,0XAB,0XF2,0XFC,0XEE,0XE0,0XCA,0XC4,0XD6,0XD8 |
| Row C | 0X9B,0X95,0X87,0X89,0XA3,0XAD,0XBF,0XB1,0XEB,0XE5,0XF7,0XF9,0XD3,0XDD,0XCF,0XC1 |
| Row D | 0X7B,0X75,0X67,0X69,0X43,0X4D,0X5F,0X51,0X0B,0X05,0X17,0X19,0X33,0X3D,0X2F,0X21 |
| Row E | 0XCC,0XC2,0XD0,0XDE,0XF4,0XFA,0XE8,0XE7,0XBC,0XB2,0XA0,0XAE,0X84,0X8A,0X98,0X96 |
| Row F | 0X2C,0X22,0X30,0X3E,0X14,0X1A,0X08,0X06,0X5C,0X52,0X40,0X4E,0X64,0X6A,0X78 |

The privacy hands free (PHF) process is illustrated in FIG. 17. The PHF mode is a mode where the phone is functioning in its normal mode as if it was not attached to a hands free unit and is held in the user's hand next to the ear and mouth. Once connected to the hands free unit, the phone can be switched from the AHF mode to the PHF mode without dropping a call if active. The communication protocol necessary to maintain intelligent communication between the hands free unit and the phone are maintained while changing privacy modes.

When the PHF PROCESS is initiated, the hands free unit is muted. If the phone is connected and the hands free unit is in the PHF MODE, a PHF CODE BASED ON THE LAST ID SENT BACK FROM THE PHONE IN THE AHF MODE is sent to the phone and a delay of 32 ms. is executed. This packet is sent to the phone every 250 ms. to maintain the phone in the PHF mode, also known as the HEART BEAT.

The specific instruction and process are as follows:

Calculate PHF packet to send based on the <BLKUP> code received in the ID packet. To calculate the PHF code to send to the phone, take the value from the big lookup table based on the dependent value received from the ID packet, we will call this the big table value, or BTV. Use the higher nibble from the BTV as an offset into Table 1 (below). This will give us our higher nibble. Use the higher nibble to use in the PHF packet. Use the lower nibble from the BTV as an offset into Table 2. This will give us the lower nibble value to use in the PHF packet. Take the two nibbles derived from Table 1 and Table 2 and bitwise them together to give the byte to use in the PHF packet.

Example: ID packet received is AF, A1 or A2. <BLKUP>. For this example <BLKUP> received is 0×6C. Use this value as the offset to the big lookup table. Row 6, column 12. The BTV value is 0×4F. Now use the higher nibble from the BTV, in this case 0×4F, higher nibble is hex

4. Use this value to look into Table 1, 4th position. Remember to always start with 0. The value in Table 1, 4th position is 0×80. Use the lower nibble from the BTV, in this case, 0×4F, lower nibble is hex.F. Hexadecimal F, is decimal 15. So looking into Table 2, 15th position, the value is 0×08. The values from Table 1 and Table 2 are 0×80, and 0×08. Performing a bitwise on these two values give you a byte with value 0×88. The PHF packet becomes 7F, AF, CC, 00, 88, 7E.

The PHF packet is sent to the phone every 200 ms. This maintains the phone in Privacy Hands Free mode.

TABLE 1
(Hexadecimal Values), Used in part to calculate PHF packet

| | |
|---|---|
| Row 0 | 0xC0,0xD0,0xE0,0xF0,0x80,0x90,0xA0,0xB0,0x40,0x50,0x60,0x70,0x00,0x10,0x20,0x30 |

TABLE 2
(Hexadecimal Values), Used in part to calculate PHF packet

| | |
|---|---|
| Row 0 | 0x07,0x06,0x05,0x04,0x03,0x02,0x01,0x00,0X0F,0x0E,0x0D,0X0C,0X0B,0x0A,0x09,0x08 |

1. A vehicle separable hands free unit for a mobile wireless telephone having internal audio circuitry for an internal speaker and an internal microphone, comprising: a base unit, a vehicle separable connector quickly connectable to the vehicle's power supply for supplying power to the base unit, said base unit including a hands free speaker and a hands free microphone, AHF control means in the base unit for commanding the telephone to disconnect the telephone's internal speaker and internal microphone and connect the internal audio circuits to the base unit and to activate the base unit hands free speaker and hands free microphone, PHF control means in the base unit for commanding the telephone to connect the telephone's internal speaker and internal microphone to the internal audio circuits and to deactivate the base unit hands free speaker and hands free microphone, and a manually operable switch in the base unit for selecting alternatively the AHF control or the PHF control.

2. A vehicle separable hands free unit for a mobile wireless telephone as defined in claim 1, wherein the switch includes a user finger operable optical switch.

3. A vehicle separable hands free unit for a mobile wireless telephone as defined in claim 1, wherein the AHF control means and the PHF control means are incorporated in part in a microprocessor in the base unit, said microprocessor generating and sending an ID request packet to the phone, receiving an ID packet from the phone to determine the model of telephone.

4. A vehicle separable hands free unit for a mobile wireless telephone as defined in claim 3, said microprocessor utilizing the ID packet from the phone to identify a look-up value on a table, said microprocessor utilizing the look-up value to generate an AHF packet and send it to the telephone as part of the AHF control means.

5. A vehicle separable hands free unit for a mobile wireless telephone as defined in claim 3, said microprocessor utilizing the ID packet from the phone to identify a look-up value in a table, said microprocessor utilizing the look-up value to generate a PHF packet and send it to the telephone as part of the PHF control means.

6. A vehicle separable hands free unit for a mobile wireless telephone as defined in claim 1, including a microprocessor in the hands free unit for requesting model number identification from the phone and utilizing that identification to develop commands to the telephone in the AHF control means and the PHF control means.

7. A vehicle separable hands free unit for a mobile wireless telephone as defined in claim 1, said base unit including a duplexing circuit for attenuating the level of the hands free microphone at predetermined values of the telephone's internal audio circuits.

8. A vehicle separable hands free unit for a mobile wireless telephone having internal audio circuitry for an internal speaker and an internal microphone, comprising: a base unit, a vehicle separable connector quickly connectable to the vehicle's power supply for supplying power to the base unit, said base unit including a hands free speaker and a hands free microphone, a microprocessor in the base unit for sending an ID request packet to the telephone and receiving a phone ID packet from the phone, said microprocessor utilizing the same ID packet to generate an AHF packet to the telephone for commanding the telephone to disconnect the telephone's internal speaker and internal microphone and connect the internal audio circuits to the base unit and to activate the base unit hands free speaker and hands free microphone.

9. A vehicle separable hands free unit for a mobile wireless telephone as defined in claim 8, said microprocessor utilizing the phone ID packet to generate a PHF packet to the telephone for commanding the telephone to connect the telephone's internal speaker and internal microphone to the internal audio circuits.

10. A vehicle separable hands free unit for a mobile wireless telephone as defined in claim 8, said microprocessor repeatedly sending the AHF packet to the telephone to maintain the telephone in an AHF mode when desired.

11. A vehicle separable hands free unit for a mobile wireless telephone as defined in claim 9, said microprocessor repeatedly sending the PHF packet to the telephone to maintain the telephone in a PHF mode when desired.

12. A vehicle separable hands free unit for a mobile wireless telephone as defined in claim 8, said microprocessor utilizing the ID packet from the phone to identify a look-up value in a table, said microprocessor utilizing the look-up value to generate an AHF packet and send it to the telephone as part of the AHF control means.

13. A vehicle separable hands free unit for a mobile wireless telephone as defined in claim 8, said microprocessor utilizing the ID packet from the phone to identify a look-up value in a table, said microprocessor utilizing the look-up value to generate a PHF packet and send it to the telephone as part of the PHF control means.

14. A vehicle separable hands free unit for a mobile wireless telephone having internal audio circuitry for an internal speaker and an internal microphone, comprising: a base unit, a vehicle separable connector quickly connectable to the vehicle's power supply for supplying power to the base unit, said base unit including a hands free speaker and a hands free microphone, a microprocessor in the base unit for sending an AHF packet to the telephone for commanding the telephone to disconnect the telephone's internal speaker and internal microphone and connect the internal audio circuits to the base unit, and to activate the base unit hands free speaker and hands free microphone, said microprocessor repeatedly sending the AHF packet to the telephone for maintaining the telephone in an AHF mode.

15. A vehicle separable hands free unit for a mobile wireless telephone as defined in claim 14, said microprocessor sending a PHF packet to the telephone for commanding the telephone to connect the telephone's internal speaker and internal microphone to the internal audio circuits, said microprocessor repeatedly sending the PHF packet to the telephone to maintain the telephone in a PHF mode.

16. An aftermarket hands free unit for a mobile wireless telephone, comprising: a base unit having an integral generally annular nose insertable into a vehicle power socket, said base including a housing with upper and lower housing portions, a circuit board clam shelled between the upper and lower housing portions, and a speaker clam shelled between the circuit board and the upper housing portion.

17. An aftermarket hands free unit for a mobile wireless telephone as defined in claim 16, wherein the upper housing portion has a grill for the speaker.

18. An aftermarket hands free unit for a mobile wireless telephone as defined in claim 16, including a finger insertable recess in the housing with a switch therein for operating the hands free unit.

19. An aftermarket hands free unit for a mobile wireless telephone as defined in claim 18, wherein the switch is an optical switch.

20. An aftermarket hands free unit for a mobile wireless telephone, comprising: a base unit having an integral generally annular nose insertable into a vehicle power socket, said base including a housing, a finger insertable recess in the housing with a switch thereon for operating the hands free unit.

21. An aftermarket hands free unit for a mobile wireless telephone as defined in claim 19, wherein the switch is an optical switch.

22. A vehicle separable hands free unit for a mobile wireless telephone having internal audio circuitry for an internal speaker and an internal microphone, comprising: a base unit, a vehicle separable connector quickly connectable to the vehicle's power supply for supplying power to the base unit, said base unit including a hands free speaker and a hands free microphone, and a duplexing circuit in the base unit for attenuating or interrupting the hands free microphone level at a predetermined audio level of the hands free speaker.

23. A vehicle separable hands free unit for a mobile wireless telephone having internal audio circuitry for an internal speaker and an internal microphone, comprising: a base unit, a vehicle separable connector quickly connectable to the vehicle's power supply for supplying power to the base unit, said base unit including a hands free speaker and a hands free microphone, and a circuit in the base unit permitting connection of the base unit to a phone during a call without interrupting the call.

24. A vehicle separable hands free unit for a mobile wireless telephone as defined in claim 23, including means for activating the base unit while the call is in process.

25. A vehicle separable hands free unit for a mobile wireless telephone having internal audio circuitry for an internal speaker and an internal microphone, comprising: a base unit, a vehicle separable connector quickly connectable to the vehicle's power supply for supplying power to the base unit, said base unit including a hands free speaker and a hands free microphone, and a circuit in the base unit for reducing echo from the speaker.

26. A vehicle separable hands free unit for a mobile wireless telephone as defined in claim 25, wherein the means to reduce echo from the speaker includes click less opto resistors.

27. A vehicle separable hands free unit for a mobile wireless telephone as defined in claim 25, including means for summing inverted ground signals with audio signals to cancel noise.
